(19) United States
(12) Patent Application Publication
(10) Pub. No.: US 2016/0062538 A1
(43) Pub. Date: Mar. 3, 2016

(54) TOUCH SCREEN PANEL AND METHOD OF MANUFACTURING THE SAME

(71) Applicant: Samsung Display Co., Ltd., Yongin-City (KR)

(72) Inventors: Jae Hyung JO, Yongin-City (KR); Young Seok YOO, Yongin-City (KR); Hyun Jae LEE, Yongin-City (KR)

(21) Appl. No.: 14/809,766

(22) Filed: Jul. 27, 2015

(30) Foreign Application Priority Data
Sep. 3, 2014 (KR) 10-2014-0117043

(51) Int. Cl. G06F 3/041

(52) U.S. Cl. CPC G06F 3/0416; G06F 2203/04103

(57) ABSTRACT

A touch screen panel includes: a touch sensing substrate provided with a hole at least one side of the touch sensing substrate; and a flexible printed circuit board inserted into the hole and electrically connected to the touch sensing substrate.

### CROSS-REFERENCE TO RELATED APPLICATION

This application claims priority to and the benefit of Korean Patent Application No. 10-2014-0117043, filed on Sep. 3, 2014, in the Korean Intellectual Property Office, the entire contents of which are incorporated herein by reference in their entirety.

### BACKGROUND

1. Field

The inventive concept relates to a touch screen panel, and a method of manufacturing the same.

2. Description of the Related Art

A touch screen panel has been used as an input device of a display device instead of a switch or a keyboard. The touch screen panel is an input device for recognizing a contact of a user applied to a specific position on a screen.

The touch screen panel includes a touch sensing substrate and a Flexible Printed Circuit Board (FPCB) electrically connected to the touch sensing substrate. The touch sensing substrate includes a base substrate, sensing electrodes, which are formed on at least one surface of the base substrate and detect a touch position of a user, and conductive lines electrically connected to the sensing electrodes. The conductive lines extend one area of the base substrate to be connected to pad units. A terminal unit of the FPCB is electrically connected to the pad units. The touch screen panel may be electrically connected to a driving circuit board through the FPCB. Driving circuits for driving the display device are embedded in a driving circuit board.

Defects may be generated in the display device including the aforementioned touch screen panel due to various reasons. Accordingly, development of various techniques for decreasing a defect rate of the display device has been demanded.

### SUMMARY OF THE INVENTION

The inventive concept has been made in an effort to solve the above-described problems associated with the prior art, and provides a touch screen panel which is waterproof and dustproof, and a method of manufacturing the same.

The inventive concept has also been made in an effort to solve the above-described problems associated with the prior art, and provides a method of manufacturing a touch screen panel, which is capable of decreasing damage of the touch screen panel having a waterproof and dustproof structure.

An exemplary embodiment of the inventive concept provides a touch screen panel, including: a touch sensing substrate provided with a hole at least one side of the touch sensing substrate; and a flexible printed circuit board inserted into the hole and electrically connected to the touch sensing substrate.

A width of the hole may be greater than a maximum width of the flexible printed circuit board.

The touch sensing substrate may include: a base substrate; sensing electrodes formed at least one surface of the base substrate; conductive lines connected to the sensing electrodes and extending toward a pad area of the base substrate, and pad units connected to the conductive lines in the pad area and connected to a terminal unit of the flexible printed circuit board.

The base substrate may include a pattern area, in which the sensing electrodes and the conductive lines are formed, and an extended area facing the pattern area with the pad area interposed therebetween and extending from the pad area, the extended area including the hole, and the extended area protects elements which do not overlap the pattern area and the pad area, and are disposed under the base substrate.

The touch screen panel may further include a window substrate disposed on the touch sensing substrate.

The touch sensing substrate may be formed to have the same size as that of the window substrate.

Another exemplary embodiment of the inventive concept provides a method of manufacturing a touch screen panel, including: bending a touch sensing substrate, which is provided with a hole at least one side of the touch sensing substrate, and seating the touch sensing substrate on a bending zig so that at least a portion of the hole is positioned above an upper surface of the bending zig; inserting a flexible printed circuit board into the hole; and compressing and bonding the flexible printed circuit board to the touch sensing substrate.

The bending zig may include a first support for supporting the touch sensing substrate, and a second support protruding from the first support and supporting the flexible printed circuit board.

The bending of the touch sensing substrate and the seating of the touch sensing substrate on the bending zig may include bending the touch sensing substrate so that the hole is opened at a higher position than the second support.

In the inserting of the flexible printed circuit board into the hole, the flexible printed circuit board may be seated on the second support.

In the bending of the touch sensing substrate and the seating of the touch sensing substrate on the bending zig, the touch sensing substrate may be spaced apart from a lateral wall of the second support vertical to a surface of the first support.

In the bending of the touch sensing substrate and the seating of the touch sensing substrate on the bending zig, the touch sensing substrate is in close contact with the lateral wall of the second support, the lateral wall being inclined to a surface of the first support.

The bending zig may include vacuum chuck adsorbing the touch sensing substrate to the bending zig.

The bending of the touch sensing substrate and the seating of the touch sensing substrate on the bending zig may include: disposing a first surface of an adhesive pad to a surface of the bending zig; and attaching the touch sensing substrate to a second surface of the adhesive pad.

According to the exemplary embodiments of the inventive concept, the touch sensing substrate is extended so that the hole, into which the flexible printed circuit board is inserted, is formed at least one side of the touch sensing substrate, so that it is possible to provide a waterproof and dustproof structure through one extended area of the touch sensing substrate.

In the inventive concept, the touch sensing substrate is bent and seated on the bending zig so that the hole is positioned above the upper surface of the bending zig. Accordingly, it is possible to easily insert the flexible printed circuit board into the hole. Further, according to the exemplary embodiments of the inventive concept, it is possible to decrease damage of the flexible printed circuit board and the touch sensing substrate when the flexible printed circuit board is compressed to the touch sensing substrate for bonding.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present between the two elements. Like reference numerals refer to like elements throughout the specification.

FIGS. 1A and 1B are diagrams for describing display devices according to exemplary embodiments of the inventive concept.

FIG. 2 is a diagram for describing a touch screen panel according to an exemplary embodiment of the inventive concept.

FIG. 3 is a diagram for describing a touch sensing substrate according to an exemplary embodiment of the inventive concept.

FIG. 4 and FIG. 5 are diagrams for describing a method of manufacturing the touch screen panel according to an exemplary embodiment of the inventive concept.

FIGS. 6A to 6D are diagrams for describing the method of manufacturing the touch screen panel by using various structures of bending zigs according to the exemplary embodiments of the inventive concept in detail.

### DETAILED DESCRIPTION OF THE INVENTION

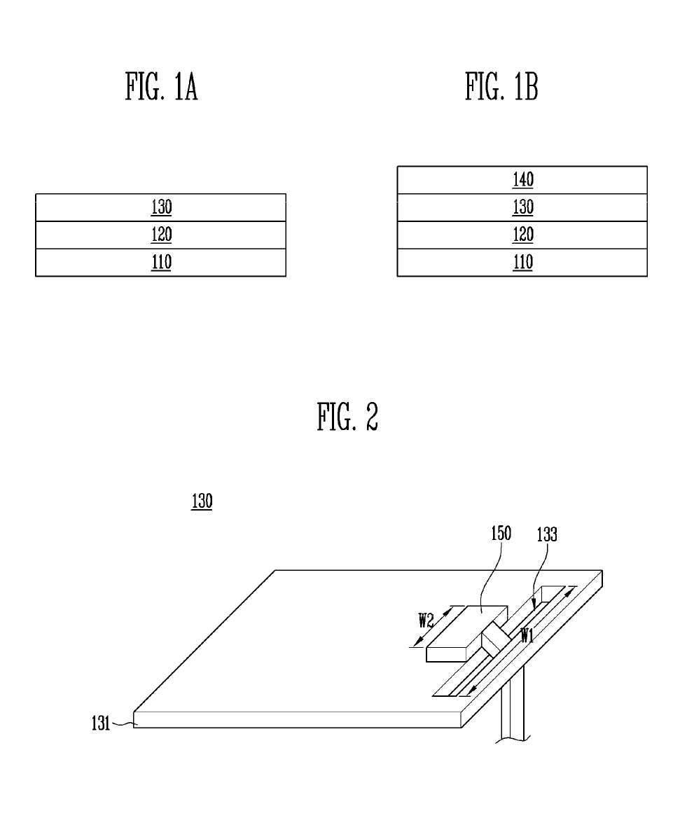

FIGS. 1A and 1B are diagrams for describing display devices according to exemplary embodiments of the inventive concept.

Referring to FIG. 1A or 1B, a display device according to an exemplary embodiment of the inventive concept includes a driving circuit board 110, a display panel 120, and a touch screen panel 130.

The driving circuit board 110 includes a circuit for driving the display device. The elements embedded in the driving circuit board 110 may be configured to receive a touch signal applied to the touch screen panel 130 and generate signals for carrying out the command by the user.

The display panel 120 is disposed on the driving circuit board 110. The display panel 120 may be connected with the driving circuit board 110 through a flexible printed circuit board (not illustrated). The display panel 120 may display an image through pixels arranged in a matrix form. Various kinds of display panel may be used as the display panel 120. For example, the display panel 120 may be various display panels, such as an organic light emitting display panel, a liquid crystal display panel, a plasma display panel, an electrophoretic display panel, and an electrowetting display panel.

The touch screen panel 130 is disposed on the display panel 120. The touch screen panel 130 is an input means of the display panel 120, and calculates a touch position of a user as coordinate information. The touch screen panel 130 may be connected to the driving circuit board 110 through the flexible printed circuit board. The touch screen panel 130 may be directly connected to the driving circuit board 110. The touch screen panel 130 may be a resistive touch panel or a capacitive touch panel.

Referring to FIG. 1B, the display device may further include a window substrate 140. The window substrate 140 is disposed on the touch screen panel 130. The window substrate 140 may be coupled to the touch screen panel 130 through a bonding member. The touch screen panel 130 may be formed to have the same size as that of the window substrate 140 to protect elements disposed under the touch screen panel 130.

The driving circuit board 110, the display panel 120, the touch screen panel 130, and the window substrate 140 are accommodated in a housing (not illustrated). The touch screen panel 130 and the window substrate 140 may be formed to have the same size as that of the housing to protect elements disposed thereunder. Particularly, when the touch screen panel 130 is formed to have the same size as that of the housing, waterproof and dustproof structures of the display device may be provided even though the window substrate 140 is omitted.

FIG. 2 is a diagram for describing the touch screen panel according to the exemplary embodiment of the inventive concept.

Referring to FIG. 2, the touch screen panel 130 includes a touch sensing substrate 131 provided with a hole 133 at one side of the sensing substrate 131, and a Flexible Printed Circuit Board (FPCB) 150 inserted into the hole 133 to be electrically connected to the touch sensing substrate 131. The touch sensing substrate 131 includes a plurality of patterns for detecting position information. The patterns for detecting the position information may be formed in various structures.

For the resistive type touch panel, the patterns for detecting the position information may include first and second resistive patterns which are spaced apart from each other. The resistive type touch panel may detect a voltage output when the first and second resistive patterns are in contact with each other by external pressure, and calculate position information about a touch of a user as coordinates.

For the capacitive type touch panel, the patterns for detecting the position information may include first and second sensing patterns which cross each other. The capacitive type touch panel may detect a change in capacity generated in the first and second sensing patterns, and calculate position information about a touch of a user as coordinates.

The patterns formed on the touch sensing substrate 131 are electrically connected to pad units, and the FPCB 150 is electrically connected to the pad units. Accordingly, the touch sensing substrate 131 may be electrically connected to the driving circuit board 110, which is aforementioned with reference to FIGS. 1A and 1B, through the FPCB 150.

The FPCB 150 may be inserted into the hole 133 of the touch sensing substrate 130, and bent toward a lower side at which the driving circuit board 110 is disposed. The hole 133 is disposed adjacent to the pad units. A size of the hole 133 is controlled so that the FPCB 150 may be inserted into the hole 133. For example, a width W1 of the hole 133 may be formed to be greater than a maximum width W2 of the FPCB 150.

The touch sensing substrate 131 may further include an extended area P3 extends from a pad area P2, to which the FPCB 150 is connected, and the hole 133 may be disposed in the extended area P3. The touch sensing substrate 131 may be formed to have the same size as that of the window substrate 140 which is aforementioned with reference to FIG. 1B.

Hereinafter, a structure of the touch sensing substrate 131 will be described in more detail based on the capacitive type touch panel as an example. However, the structure of the touch sensing substrate 131 is not limited to the capacitive type touch panel.

FIG. 3 is a diagram for describing the touch sensing substrate according to the exemplary embodiment of the inventive concept.

Referring to FIG. 3, the touch sensing substrate 131 includes a base substrate SUB including a pattern area P1, a pad area P2, and an extended area P3, sensing electrodes 135a and 135b and conductive lines 137a and 137b disposed in the pattern area P1, pad units 139a and 139b disposed in the pad area P2, and the hole 133 disposed in the extended area P3.

The base substrate SUB is formed of a flexible film. For example, the base substrate SUB may be formed of polyethylene terephthalate (PET).

The sensing electrodes 135a and 135b and the conductive line 137a and 137b are formed at least one surface of the base substrate SUB in the pattern area P1. For the capacitive type touch panel, the sensing electrodes 135a and 135b includes first sensing electrodes 135a and second sensing electrodes 135b which are formed to cross each other in a sensing area SA. The conductive lines 137a and 137b include first conductive lines 137a connected to the first sensing electrode 135a and extend to the pad area P2, and second conductive lines 137b connected to the second sensing electrode 135b and extend to the pad area P2. The sensing electrodes 135a and 135b may be formed of a transparent conductive material. For example, the sensing electrodes 135a and 135b may be formed of an Indium Tin Oxide (ITO) or an Indium Zinc Oxide (IZO). The conductive lines 137a and 137b may be formed of metal having low resistance. For example, the conductive lines 137a and 137b may be formed of metal having low resistance, such as Ag, Al, Cu, Cr, and Ni.

The pad units 139a and 139b are formed in the pad area P2 of the base substrate SUB. The pad units 139a and 139b include first pad units 139a connected to the first conductive lines 137a, respectively, and second pad units 139b connected to the second conductive lines 137b, respectively. The pad units 139a and 139b are concentrated in the pad area P2, and connected to the terminal unit of the FPCB 150 aforementioned with reference to FIG. 2. The pad units 139a and 139b may be formed of metal having low resistance.

The extended area P3 is an area disposed to face the pattern area P1 with the pad area P2 interposed therebetween, and extends from the pad area P2. The extended area P3 has a hole 133 in which the FPCB may pass through to be connected to the pad units 139a and 139b. The extended area P3 includes an area surrounding the hole 133, so that the extended area P3 may protect elements, which do not overlap with the pattern area P1 and the pad area P2 and are disposed under the extended area P3.

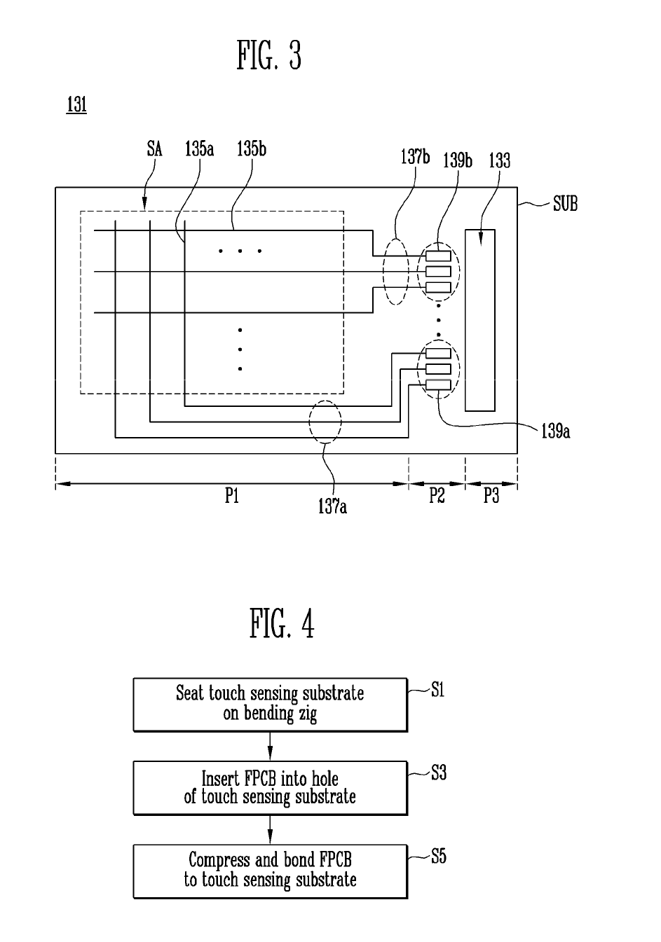

FIGS. 4 and 5 are diagrams for describing a method of manufacturing the touch screen panel according to an exemplary embodiment of the inventive concept.

Referring to FIGS. 4 and 5, the touch sensing substrate 131 is first seated on a bending zig 160 by transferring the touch sensing substrate 131 to the bending zig 160 in step S1. In this case, the pad units face upward so that the pad units 139a and 139b (see FIG. 3) of the touch sensing substrate 131 may be exposed. In step S1, the touch sensing substrate 131 is bent and seated on the bending zig 160 so that at least a portion of the hole 133 formed in the extended area is positioned above the upper surface of the bending zig 160 and does not contact the bending zig 160. That is, the hole 133 is opened at a higher position that the second support 163a. The touch sensing substrate 131 is spaced apart from a lateral wall of the second support 163a which is substantially vertical to a surface of the first support 161. The touch sensing substrate 131 is in close contact with a lateral support inclined to a surface of the first support 161 to be seated on the bending zig 160. The touch sensing substrate 131 is in close contact with the lateral wall of the second support, the lateral wall being inclined to a surface of the first support.

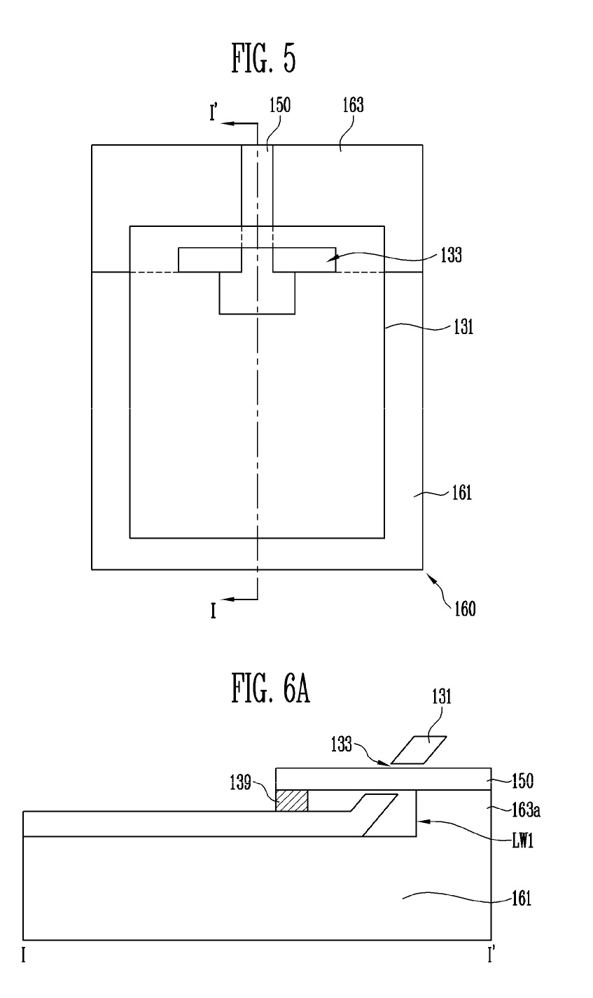

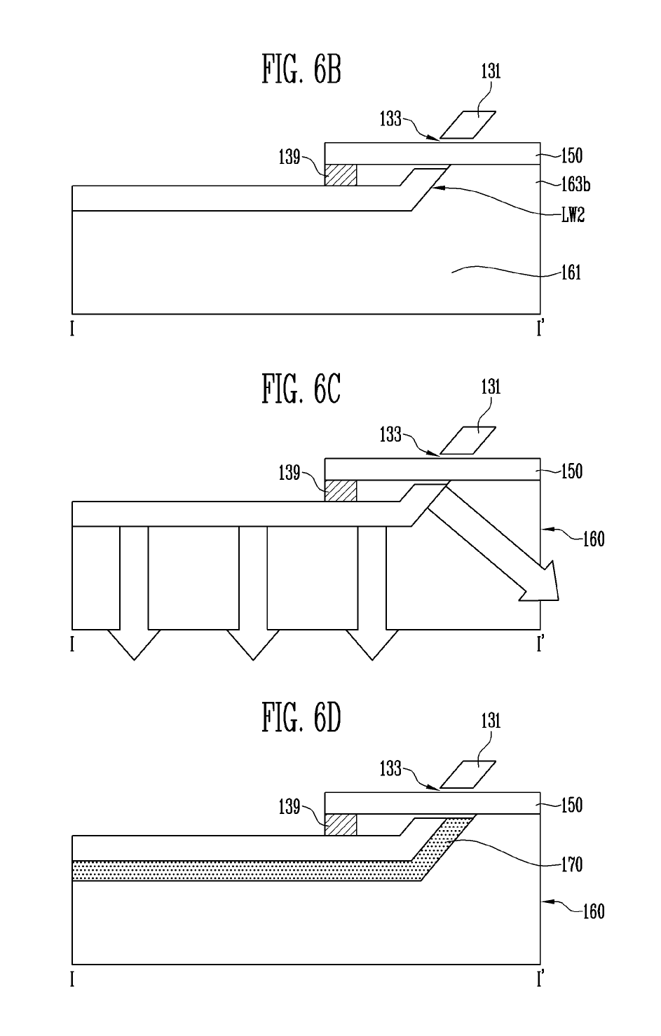

The bending zig 160 includes a first support 161 and a second support 163 protruding from the first support 161 toward a direction substantially perpendicular to the first support 161 so as to support the touch sensing substrate 131 in a bent state. The first support 161 may support the pattern area P1 and the pad area P2 of the touch screen substrate 131. The second support 161 may support the FPCB 150. The bending zig 160 may be formed in various structures, which will be described below with reference to FIGS. 6A to 6D.

Next, the FPCB 150 is inserted into the hole 133 in the touch sensing substrate 131 in step S3. The FPCB 150 may be supported by an upper surface of the second support 163.

Then, the FPCB 150 is compressed and bonded to the touch sensing substrate 131 in step S5. The FPCB 150 and the touch sensing substrate 131 may be bonded to each other by a high-temperature and high-pressure compressing method using an Anisotropic Conductive Film (ACF).

FIGS. 6A to 6D are diagrams for describing the method of manufacturing the touch screen panel by using various structures of bending zigs according to the exemplary embodiments of the inventive concept in detail. FIGS. 6A to 6D are cross-sectional views illustrating the bending zig 160, the touch sensing substrate 131, and the FPCB 150 illustrated in FIG. 5 taken along line I-I′.

Referring to FIGS. 6A and 6B, the bending zig includes a first support 161 for supporting the touch sensing substrate 131, and a second support 163a or 163b protruding from the first support 161 substantially perpendicular to the first support 161 to support the flexible printed circuit board 150.

Referring to FIG. 6A, the second support 163a may have a lateral wall LW1 vertical to a surface of the first support 161. In this case, the touch sensing substrate 131 may be spaced apart from the lateral wall LW1 of the second support 163a, bent by the second support 163a, and supported by an upper surface of the first support 161 and a corner of the second support 163a to be seated on the bending zig.

Referring to FIG. 6B, the second support 163b may have a lateral wall LW2 inclined with respect to the surface of the first support 161. In this case, the touch sensing substrate 131 may be in close contact with the lateral wall LW2 of the second support 163b, bent by the second support 163b, and supported by the upper surface of the first support 161 and the lateral wall of the second support 163b to be seated on the bending zig.

As described above, the touch sensing substrate 131 may be bent and seated on the bending zig by using the structure of the bending zig including the first support 161 and the second support 163a or 163b. A position of the touch sensing substrate 131 is controlled so that at least a portion of the hole 133 of the touch sensing substrate 131 may be higher than the upper surface of the second support 163a or 163b when the touch sensing substrate 131 is seated in the bent state. The upper portion of the hole 133 may be higher than the upper surface of the FPCB 150.

When the FPCB 150 is inserted into the hole 133 of the touch sensing substrate 131, the FPCB 150 may be seated on the upper surface of the second support 163a or 163b. At least a portion of the hole 133 of the touch sensing substrate 131 may be opened at the higher position than the upper surface of the second support 163a or 163b, so that the FPCB 150 may be easily inserted into the hole 133 in the touch sensing substrate 131 in the state where the FPCB 150 is supported by the upper surface of the second support 163a or 163b. The terminal unit formed at one end of the FPCB 150 is disposed to be in contact with the pad unit 139 of the touch sensing substrate 131.

The touch sensing substrate 131 is bent by using the structure of the bending zig so that the hole 133 is opened to the outside of the bending zig and the FPCB 150 and the hole 133 are disposed on a straight line. Accordingly, the inventive concept may decrease damage of the touch sensing substrate 131 and the FPCB 150 during a process of compressing and bonding the touch sensing substrate 131 and the FPCB 150.

Referring to FIG. 6C, the touch sensing substrate 131 may be attached to bending zig 160 using a vacuum chuck as illustrated in FIG. 6C. Accordingly, the touch sensing substrate 131 may be stably fixed to the bending zig 160.

Referring to FIG. 6D, an adhesive pad 170 is disposed on the surface of the bending zig 160. The touch sensing substrate 131 may be attached to the adhesive pad 170 to a second surface of the adhesive pad 170. Accordingly, the touch sensing substrate 131 may be stably fixed to the bending zig 160. Adhesive force of the adhesive pad 170 is formed to be weak so that the touch sensing substrate 131 is easily detachable after the FPCB 150 is bonded to the touch sensing substrate 131. To this end, the adhesive pad 170 may be formed of a low viscosity adhesive material. For example, the adhesive pad 170 may be formed of an acryl or silicon based material.

The bending zig described with reference to FIG. 6A or the bending zig described with reference to FIG. 6B may be used as the bending zig 160 of FIGS. 6C and 6D.

As described above, according to the inventive concept, the touch sensing substrate extends beyond the pad area to form a hole into which FPCB is inserted, so that it is possible to provide a waterproof and dustproof structure through the extended area of the touch sensing substrate.

Further, according to the inventive concept, the touch sensing substrate is bent and seated on the bending zig so that the hole is exposed. Accordingly, in the inventive concept, it is possible to easily insert the FCBP into the hole. Further, the inventive concept may decrease damage of the FCBP and the touch sensing substrate when the FCBP and the touch sensing substrate are compressed for bonding.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the inventive concept as set forth in the following claims.

What is claimed is:

1. A touch screen panel, comprising:
a touch sensing substrate provided with a hole at least one side of the touch sensing substrate; and
a flexible printed circuit board inserted into the hole and electrically connected to the touch sensing substrate.

2. The touch screen panel of claim 1, wherein a width of the hole is greater than a maximum width of the flexible printed circuit board.

3. The touch screen panel of claim 1, wherein the touch sensing substrate includes:
a base substrate;
sensing electrodes formed at least one surface of the base substrate;
conductive lines connected to the sensing electrodes and extending toward a pad area of the base substrate; and
pad units connected to the conductive lines in the pad area and connected to a terminal unit of the flexible printed circuit board.

4. The touch screen panel of claim 3, wherein the base substrate includes a pattern area, in which the sensing electrodes and the conductive lines are formed, and an extended area facing the pattern area with the pad area interposed therebetween and extending from the pad area, the extended area including the hole, and
the extended area protects elements which do not overlap with the pattern area and the pad area, and are disposed under the base substrate.

5. The touch screen panel of claim 1, further comprising:
a window substrate disposed on the touch sensing substrate.

6. The touch screen panel of claim 5, wherein the touch sensing substrate is formed to have the same size as that of the window substrate.

7. A method of manufacturing a touch screen panel, comprising:
bending a touch sensing substrate, which is provided with a hole at least one side of the touch sensing substrate, and seating the touch sensing substrate on a bending zig so that at least a portion of the hole is positioned above an upper surface of the bending zig;
inserting a flexible printed circuit board into the hole; and
compressing and bonding the flexible printed circuit board to the touch sensing substrate.

8. The method of claim 7, wherein a width of the hole is greater than a maximum width of the flexible printed circuit board.

9. The method of claim 7, wherein the bending zig includes a first support for supporting the touch sensing substrate, and a second support protruding from the first support and supporting the flexible printed circuit board.

10. The method of claim 9, wherein the bending of the touch sensing substrate and the seating of the touch sensing substrate on the bending zig includes bending the touch sensing substrate so that the hole is opened at a higher position than the second support.

11. The method of claim 9, wherein in the inserting of the flexible printed circuit board into the hole, the flexible printed circuit board is seated on the second support.

12. The method of claim 9, wherein in the bending of the touch sensing substrate and the seating of the touch sensing substrate on the bending zig, the touch sensing substrate is spaced apart from a lateral wall of the second support vertical to a surface of the first support.

13. The method of claim 9, wherein in the bending of the touch sensing substrate and the seating of the touch sensing substrate on the bending zig, the touch sensing substrate is in close contact with the lateral wall of the second support, the lateral wall being inclined to a surface of the first support.

14. The method of claim 7, wherein the bending zig includes vacuum chuck adsorbing the touch sensing substrate to the bending zig.

15. The method of claim 7, wherein the bending of the touch sensing substrate and the seating of the touch sensing substrate on the bending zig includes:
disposing a first surface of an adhesive pad to a surface of the bending zig; and
attaching the touch sensing substrate to a second surface of the adhesive pad.
